(19) United States
(12) Patent Application Publication
(10) Pub. No.: US 2005/0052422 A1
(43) Pub. Date: Mar. 10, 2005

(54) Linkage mechanism of keyswitch

(76) Inventor: Chin Jen Kuo, Chungho City (TW)

Correspondence Address: BIRCH STEWART KOLASCH & BIRCH, PO BOX 747, FALLS CHURCH, VA, 22040-0747, US

(21) Appl. No.: 10/836,230

(22) Filed: May 3, 2004

(30) Foreign Application Priority Data
Sep. 5, 2003 (TW) 92216131

(51) Int. Cl. A47F 7/00; G09G 5/00

(52) U.S. Cl. 345/168

(57) ABSTRACT

A linkage mechanism of a keyswitch has a first rack and a second rack. The first rack has a pair of pivotal pins which respectively project from middles of two sides thereof, and the second rack has a pair of pivotal hole portions which are respectively formed in middles of two sides thereof. Each pivotal hole portion defines a piercing hole and a through hole which communicates with the piercing hole. Furthermore, the pivotal pins of the first rack pass through the piercing holes in a predetermined direction, and then are inserted into the through holes of the second rack, so that the pivotal pins of the first rack are inseparable in an enforced direction during operation.

### BACKGROUND OF THE INVENTION

1. Field of the Invention

The present invention relates to a linkage mechanism of a keyswitch and, more particularly, to a linkage mechanism of the keyswitch for use in a keyboard of a notebook computer, which can be easily assembled in a predetermined direction and inseparable in an enforced direction during operation.

2. Description of the Related Art

Referring to FIG. 1, a conventional keyswitch structure for a notebook computer generally includes a key cap 80, a resilient body 81, a first rack 82, a second rack 83 and a base plate 84. The first rack 82 has a pair of pivotal pins 86 formed at middles of two sides thereof, and the second rack 83 has a pair of pivotal hole portions 87 used to engage with the pivotal pins 86 of the first rack 82. Thus, the first rack 82 and the second rack 83 are pivotally connected to each other, thereby to constitute a scissors-like linkage mechanism.

The first rack 82 has two pivotal pins formed on two sides of a bottom thereof, and the pivotal pins are respectively pivotally connected to two first positions of the base plate 84. The second rack 83 has two pivotal pins formed on two sides of a bottom thereof, and the pivotal pins are respectively pivotally connected to two second positions of the base plate 84. The first rack 82 has two pivotal rods formed on two sides of a top thereof, and the pivotal rods are respectively pivotally connected to two first positions of the key cap 80. The second rack 83 has two pivotal rods formed on two sides of a top thereof, and the pivotal rods are respectively pivotally connected to two second positions of the key cap 80.

The resilient body 81 is disposed on the base plate 84. The resilient body 81 is positioned below the first rack 82 and the second rack 83 for providing a resilience when the key cap 80 is pressed or released. Further, the key cap 80 can be guided by the first rack 82 and the second rack 83 to move up and down, and the resilient body 81 below the key cap 80 can thereby be pressed on or detached from a flexible circuit board 85 to turn on or turn off the keyswitch.

However, the second rack 83 is formed as a substantially U-shaped arm member, and two side arms of the second rack 83 thus are weak such that the second rack 83 is liable to deform or to be broken during assembly or disassembly. Besides, each pivotal hole portion 87 of the second rack 83, due to the above-described keyswitch structure, is designed in a through hole (or a round hole) manner. Therefore, it is difficult to assemble the longer pivotal pins 86 of the first rack 82 into the through hole of the pivotal hole portions 87 of the second rack 83, and the shorter pivotal pins 86 of the first rack 82 are easily separated from the through hole of the pivotal hole portions 87 of the second rack 83.

Referring to FIG. 2, another conventional keyswitch mainly provides a first rack 82′ and a second rack 83′ respectively having a pair of pivotal pins 86′ and a pair of pivotal hole portions 87′ in which the pair of pivotal pins 86′ and the pair of pivotal hole portions 87′ are pivotally connected to each other. Each pivotal hole portion 87′ of the second rack 83′ is designed in a piercing hole (or a C-shaped hole) manner. The pivotal pins 86′ of the first rack 82′ are thus easily assembled into the pivotal hole portions 87′ of the second rack 83′, i.e., the pivotal pins 86′ of the second rack 83′ can be directly hooked into the piercing hole of the pivotal holes 87′ of the first rack 82′ in a predetermined direction; hence, the deformation or breakage of first rack 82′ and second rack 83′ can be prevented as disclosed in U.S. Pat. No. 6,382,856. But due to the pierce hole design of the pivotal hole portion 87′, the pivotal pins 86′ are extremely easily separated from opening ends of the piercing holes of the pivotal hole portions 87′ in an enforced direction, which is disadvantageous.

U.S. Pat. No. 5,488,210 discloses a push button switch including a key top supported on first and second crossed arm members. The first and second crossed arm members respectively include parallel legs, such as substantially U-shaped arm members. The two sides of the arm members still don't have sufficient strength as in the above-mentioned structure.

Furthermore, there presently exists a need for strength of the structures and the ability to facilitate assembly of the racks, simultaneously.

### SUMMARY OF THE INVENTION

It is therefore a principal object of the present invention to provide a linkage mechanism of a keyswitch for facilitating assembly of racks in a predetermined direction and inseparability in an enforced direction during operation.

It is another objection of the present invention to provide a linkage mechanism which, during assembly and disassembly, has greater strength to prevent the deformation and breakage due to the O-shaped racks. Furthermore, the present invention has been accomplished to overcome the aforesaid problems.

To achieve the above objects, the present invention provides a linkage mechanism of a keyswitch for use in a keyboard of a notebook computer. The linkage mechanism includes a first rack and a second rack. The first rack has a pair of pivotal pins which respectively project from middles of two sides thereof, and the second rack has a pair of pivotal holes which are respectively formed in middles of the two sides thereof. Each pivotal hole defines a piercing hole and a through hole which communicates with the piercing hole. The pivotal pins of the first rack passthrough the piercing holes in a predetermined direction, and then are inserted (assembled) into the through holes of the second rack, so that the pivotal pins of the first rack are inseparable in an enforced direction due to the fact that stop walls enclose the through holes.

To provide a further understanding of the invention, the following detailed description illustrates embodiments and examples of the invention, this detailed description being provided only for illustration of the invention.

### BRIEF DESCRIPTION OF THE DRAWINGS

The drawings included herein provide a further understanding of the invention. A brief introduction of the drawings is as follows:

FIG. 1 is a perspective exploded view of a conventional keyswitch;

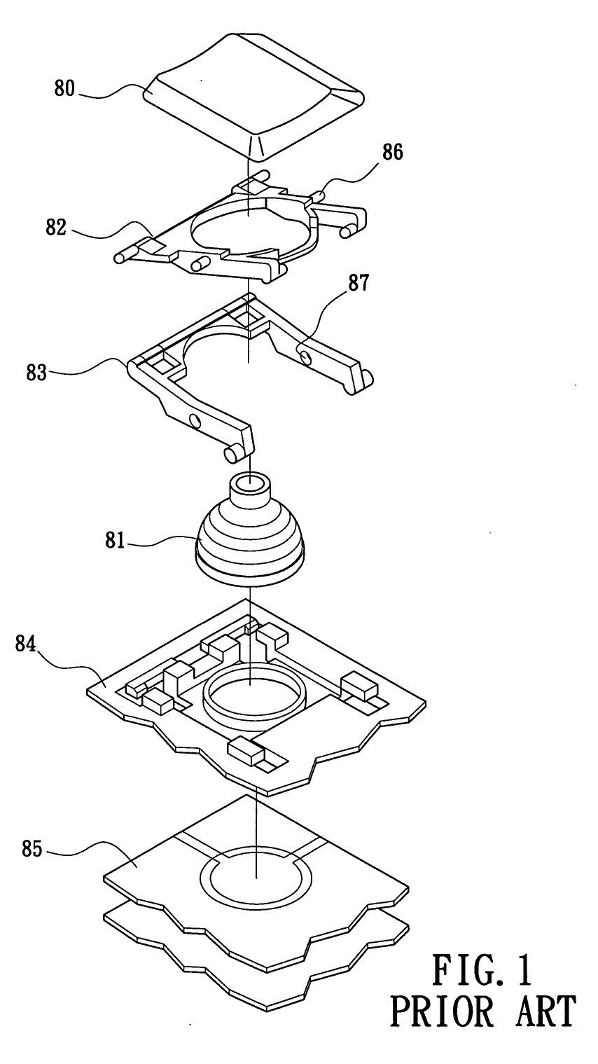

FIG. 2 is a perspective exploded view of another conventional keyswitch;

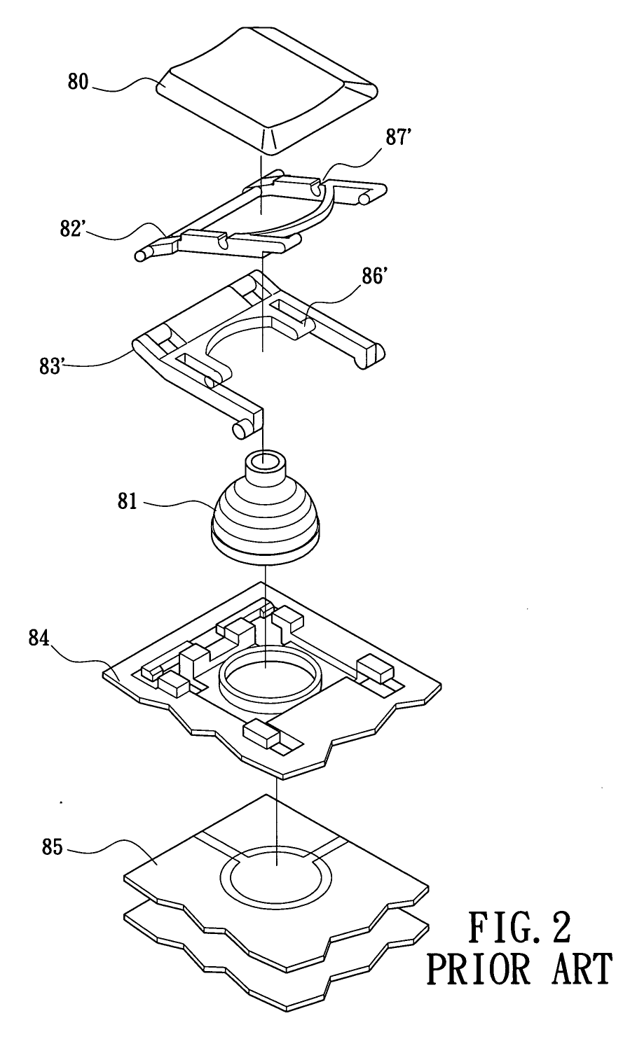

FIG. 3 is a perspective view of a first rack of the present invention;

FIG. 4 is a perspective view of a second rack of the present invention;

FIG. 5 is a perspective view of a linkage mechanism of the present invention; and

FIG. 6 is a perspective view of the linkage mechanism coupled to a key cap of the present invention.

### DETAILED DESCRIPTION OF THE EMBODIMENTS

Wherever possible in the following description, like reference numerals will refer to corresponding elements and parts unless otherwise illustrated.

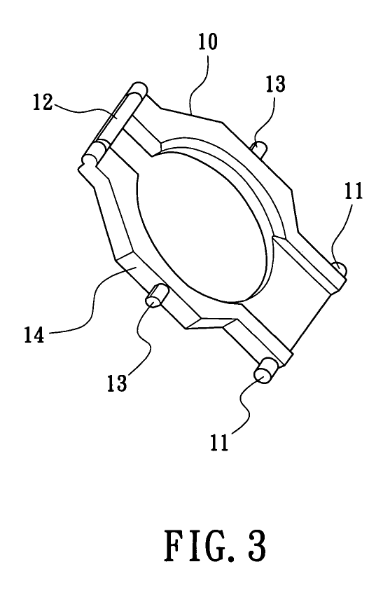

Referring to FIGS. 3 to 5, a linkage mechanism of a keyswitch for use in a keyboard of a notebook computer, such as a notebook computer, in accordance with the present invention mainly includes a first rack 10 and a second rack 20, both of which can be easily assembled in a predetermined direction and is inseparable in an enforced direction during operation.

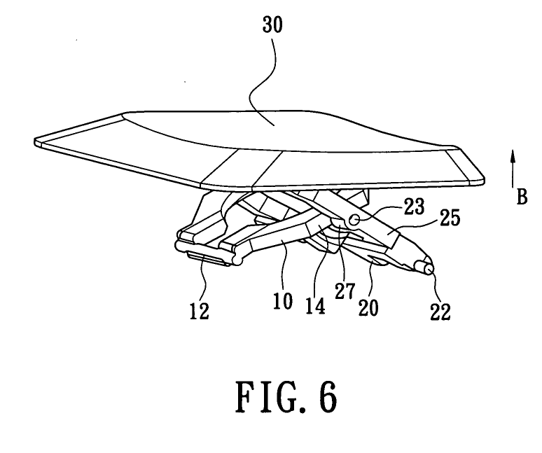

The first rack 10 is a substantially O-shaped arm member (shown in FIG. 3) in which a resilient body (not shown) is received. Upper end and lower end of the first rack 10 are respectively provided with a connecting rod 12 and with connecting pins 11, so that through using the connecting rod 12 and the connecting pins 11, the upper end and lower end of the first rack 10 can be respectively connected to a key cap 30 (shown in FIG. 6) and to a base plate (not shown). At middles of both sides of the first rack 10 are respectively provided with pivotal pins 13 which project outwardly from outer edges 14 of the first rack 10.

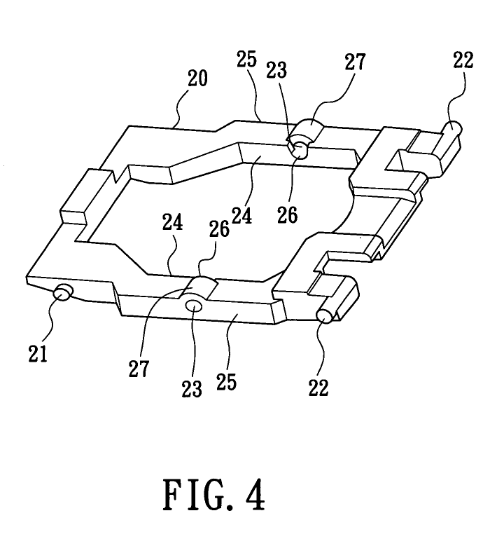

The second rack 20 is a substantially O-shaped arm member (shown in FIG. 4) and width of the second rack 20 is longer than that of the first rack 10, so that the second rack 20 can receive the resilient body and the first rack 10 simultaneously. Upper end and lower end of the second rack 20 are respectively provided with two connecting pins 21 and with two connecting rods 22, so that through using the two connecting pins 21 and the two connecting rods 22, the upper end and lower end of the second rack 20 can be respectively connected to the key cap 30 (shown in FIG. 6) and to a base plate (not shown). At middles of two sides of the second rack 20 are respectively provided with two through holes 23 which correspond to the pivotal pins 13. The two through holes 23 pass from inner edges 24 of the second rack 20 through outer edges 25 of the second rack 20.

The present invention is to form a piercing hole 26 in each side wall of the two through holes 23. The piercing holes 26 which are formed in the side walls are adjacent to the inner edges, so that portions of the side walls of the two through holes 23, which portions are adjacent to the inner edges 24, are hollow-shaped; on the contrary, portions of the side walls of the two through holes 23, which portions are adjacent to the outer edges 25, are not hollow-shaped and still have sufficient stop walls 27 for enclosing the side walls of the two through holes 23.

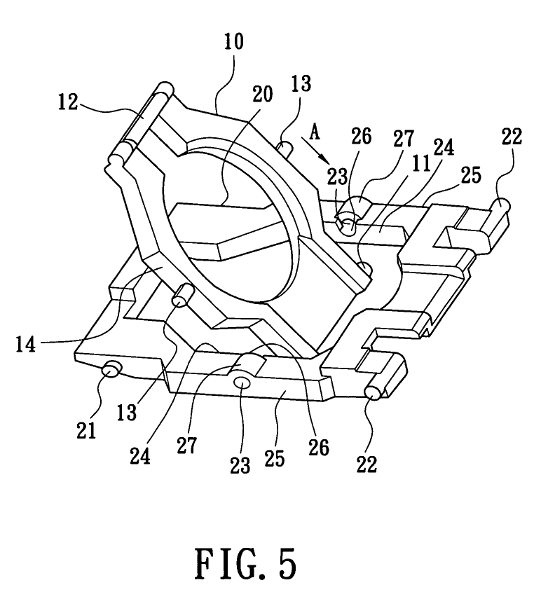

The first rack 10 and the second second rack 20 are pivotally connected as a scissor-like linkage mechanism through using the pivotal pins 13 and the through holes 23, both of which correspond to each other (shown in FIGS. 5 and 6). When the key cap 30 moves up and down in a manner that the key cap 30 is guided by the first rack 10 and the second rack 20, a resilient body (not shown) installed below the key cap 30 will contact a lower flexible circuit board (not shown) in order to achieve “ON” or will get away from the lower flexible circuit board in order to achieve “OFF”. Through the above-mentioned arrangement, the linkage mechanism of the keyswitch in accordance with the present invention, for use in a keyboard of a notebook computer can be achieved.

As described above, the present invention provides a design of forming the piercing holes 26 in the side walls of the through holes 23; therefore, the pivotal pins 13 of the first rack 10 pass through the piercing holes 26 and then are inserted (assembled) into the through holes 23, so that it is very easy to assemble the pivotal pins 13 of the first rack 10 into the through holes 23 of the second rack 20. Thus, it is very easy to assemble the above-mentioned linkage mechanism.

Furthermore, because the portions of the side walls of the two through holes 23, which portions are adjacent to the outer edges 25, are not hollow-shaped and still have sufficient stop walls 27 for enclosing the side walls of the two through holes 23, so that the pivotal pins 13 of the first rack 10 can be stably positioned in the stop walls 27 of the through holes 23 of the second rack 20; therefore, the pivotal pin 13 of the first rack 10 will not be separated, in the enforced direction (indicated by the arrow B in FIG. 6), from the through holes 23 of the second rack 20 due to the obstruction achieved by the stop walls 27 of the pivotal holes. The linkage mechanism will thus be inseparable in the enforced direction when the keyswitch is operated.

There has thus been described a new, novel and heretofore unobvious linkage mechanism which eliminates the aforesaid problem in the prior art. Furthermore, those skilled in the art will readily appreciate that the above description is only illustrative of specific embodiments and examples of the invention. The invention should therefore cover various modifications and variations made to the herein-described structure and operations of the invention, provided they fall within the scope of the invention as defined in the following appended claims.

1. A linkage mechanism of a keyswitch for use in a keyboard of a notebook computer, the linkage mechanism comprising:
a first rack having a pair of pivotal pins which respectively project from middles of two sides thereof; and
a second rack having a pair of pivotal hole portion which are respectively formed in middles of two sides thereof, in which each pivotal hole defines a piercing hole which is adjacent to an inner edge of the second rack, and each pivotal hole portion defines a through hole which communicates with the piercing hole,
wherein the pivotal pins of the first rack pass through the piercing holes of the second rack in a predetermined direction, and then are inserted into the through holes of the second rack, in order to form a scissors-like linkage mechanism, whereby the pivotal pins of the first rack are inseparable in an enforced direction due to the fact that stop walls enclose the through holes.

2. The linkage mechanism of claim 1, wherein the pivotal pins respectively project from outer edges of the first rack.

3. The linkage mechanism of claim 1, wherein width of the second rack is longer than that of the first rack.

4. The linkage mechanism of claim 1, wherein the first rack is a substantially O-shaped arm member.

5. The linkage mechanism of claim 1, wherein the second rack is a substantially O-shaped arm member.

6. The linkage mechanism of claim 1, wherein upper end and lower end of first rack are respectively provided with a connecting rod and with connecting pins, in order to be connected to a key cap.

7. The linkage mechanism of claim 1, wherein upper end and lower end of the second rack are respectively provided with two connecting pins and with two connecting rods, in order to be respectively connected to the key cap.
